(19) United States
(12) Patent Application Publication
(10) Pub. No.: US 2022/0221672 A1
(43) Pub. Date: Jul. 14, 2022

(54) OPTICAL PATH LENGTH ADJUSTING DEVICE

(71) Applicant: EZCONN CORPORATION, New Taipei City (TW)

(72) Inventors: Chin-Tsung Wu, New Taipei City (TW); Chun Yu Chen, New Taipei City (TW)

(21) Appl. No.: 17/571,617

(22) Filed: Jan. 10, 2022

Related U.S. Application Data
(60) Provisional application No. 63/135,045, filed on Jan. 8, 2021.

(51) Int. Cl. G02B 6/44; G02B 6/27

(52) U.S. Cl. CPC G02B 6/444; G02B 6/2753

(57) ABSTRACT

The present invention discloses an optical path length adjusting device, having a body, an optical path moving shaft, and an optical path adjusting screw, an auxiliary rod, and a connecting plate. By adjusting the optical path moving shaft, the optical path adjusting rod, and the auxiliary rod, and the connecting plate, the optical path can be adjusted after the light injected from the optical fiber into the optical path adjusting device. The present invention further comprises at least a bearing to stably drive a single direction of movement. The optical path length adjusting device will not cause angular deviation in the process of adjusting the optical path.

### RELATED APPLICATIONS

This application claims the benefit and priority of provisional Application No. 63/135,045, filed Jan. 8, 2021, which is incorporated herein by reference in its entirety.

### TECHNICAL FIELD

The present invention relates to an optical path length adjusting device. More particularly, the invention relates to an optical path length adjusting device that is capable of adjusting the focal length and the optical path.

### BACKGROUND

To face the advent of a highly information-based society, communication infrastructure is needed to transmit various kinds of information, such as voice, text, data, images, etc. In the past, copper cable networks could not provide such a huge demand for information. Instead, optical communication network was developed to transmit information. In optical communication networks, optical fiber is usually used as the medium for light transmission. The optical fibers have the advantages of low loss and wide bandwidth, which are suitable for information transmission over long distances. However, the arrangement of the elements between optical fibers and adjusting the signal transmission have become a serious topic.

Generally, when detecting a specific sample, there will be a reference end light source and a sample end light source. The reference end light source and the sample end light source are emitted separately, and then rejoin to a certain point. In the process of rejoining, the light path must be adjusted to be consistent so as to generate the interference spectrum required for detection.

In a prior technology, adjustment is made at the reference end only, that is, there is no corresponding adjustment part at the sample end. Arranging an optical delay line in the reference end is one of the technical way to time delaying between light paths. In a prior art, the reflector (mirror) inside the optical can be moved back and forth via the slides on the sides outside the optical delay line structure. The optical distance is adjusted along with the distance between the optical fiber and the reflector. In addition, the angle of the reflector can be changed to adjust the light intensity when returning to the optical fiber. Part of the light waves will deviate from the original input path and will not return to the fiber again, so as to attenuate the light intensity. Furthermore, in another prior art, a rotating frame is installed on the side of the reflector, so that reflector can be rotated along its axis via the movements of the rotating frame.

However, the adjustment of light path only happens in the reference end. With the increase of the global population and the development of technology, the equipment and tools in the field of optical transmission aim at reducing the overall size and convenience. If the optical path adjustment function is also arranged at the sample end, the light path can be adjusted on the sample end. And it will be easier to operate and calibrate, so as to reduce the complicated design of the reference end. Moreover, if the samples under test are increased, multiple optical path adjusting devices can also be set on the sample end to adjust individually, so that the optical path adjustment process in the overall optical system can be more precise and simple.

Accordingly, an optical path length adjusting device is desired.

### SUMMARY

To solve the problems in the prior art, an optical delay line structure is provided in the present invention. Via setting the optical path adjusting device at the sample end instead of only installing the optical delay line at the reference light end, so as to increase the number of samples under test. At this time, the optical path length difference can be directly adjusted at the sample end, the optical path length is adjusted to be almost the same as the optical path length of the reference end, so that the interference spectrum required by the detection light source can be generated.

Since the optical path length adjustment structure is directly integrated on the sample probe instead of using an additional optical path adjusting device design. It not only reduces the external occupied space, but also reduces the number of components in the overall inspection system.

An optical path length adjusting device is provided in the present invention, using for setting at least a sample under test, and adjusting an optical path length from an optical fiber. The optical path length adjusting device comprises a body, an optical path moving shaft, and an optical path adjusting rod and a connecting plate. The optical path moving shaft connects to the body, and the optical fiber is disposed in the optical path moving shaft. The optical path adjusting rod is configured through the body, and the optical path adjusting rod rotating relative to the body. The connecting plate connects to the optical path moving shaft and the optical path moving shaft, when the optical path adjusting rod rotating relative to the body, the connecting plate moving on the optical path adjusting rod and driving the optical path moving shaft to move relative to the body.

In some embodiments, further comprising a first linear bearing, the first linear bearing is disposed on the body, and the optical path adjusting rod is connected to the body through the first linear bearing.

In some embodiments, further comprising a spring, the spring is disposed through the optical path adjusting rod, and located between the connecting plate and the body.

In some embodiments, further comprising a ball bearing, the ball bearing is disposed on the body, and the optical path adjusting rod is disposed through the ball bearing.

In some embodiments, further comprising a fixing nut, the fixing nut is disposed on the body, and one end of the optical path adjusting rod is disposed through the fixing nut.

In some embodiments, further comprising a spring, a ball bearing and a fixing nut, and the optical path adjusting rod having an optical path adjusting rod head, an optical path adjusting rod body and an optical path adjusting rod tail, the spring and the ball bearing are disposed through the optical path adjusting rod body in sequence, and the fixing nut is disposed through the optical path adjusting rod tail.

In some embodiments, wherein the optical path adjusting rod having an optical path adjusting rod head, an optical path adjusting rod body and an optical path adjusting rod tail, the optical path adjusting rod body is connected to the optical path adjusting rod head and the optical path adjusting rod tail, and the outer diameter of the optical path adjusting rod head is not less than the outer diameter of the optical path adjusting rod body, the outer diameter of the optical path adjusting rod tail is not greater than the outer diameter of the optical path adjusting rod body.

In some embodiments, further comprising an auxiliary rod, the auxiliary rod is connected to the body and the connecting plate.

In some embodiments, further comprising an auxiliary rod and a second linear bearing, the auxiliary rod is connected to the connecting plate, the auxiliary rod is disposed on the second linear bearing, and the second linear bearing is disposed on the body.

In some embodiments, further comprising an auxiliary rod, the auxiliary rod is connected to the body and the connecting plate and the outer diameter of the auxiliary rod is not less than the outer diameter of the optical path adjusting rod.

In some embodiments, further comprising a parallel light lens, the parallel light lens is disposed in the optical path moving shaft.

In some embodiments, further comprising a reflecting mirror, the reflecting mirror is disposed on the body.

In some embodiments, further comprising a focusing lens, the focusing lens is disposed on the body.

In some embodiments, further comprising a Microelectromechanical Systems(MEMS) circuit adapter board and a Microelectromechanical Systems(MEMS) scan mirror, the Microelectromechanical Systems circuit adapter board is connected to the Microelectromechanical Systems scan mirror, and the Microelectromechanical Systems circuit adapter board is disposed on the body.

In some embodiments, further comprising a parallel light lens, a reflecting mirror and a Microelectromechanical Systems scan mirror, a focusing lens and a detection exit, the optical path length emitted from the optical fiber is sequentially along the parallel light lens, the reflecting mirror, the Microelectromechanical Systems scanning mirror and the focusing lens to the detection exit.

In some embodiments, the body is having a first side and a second side, the first side and the second side are correspondingly arranged, and the optical fiber, the optical path moving shaft and the connecting plate are located on the second side of the body.

In some embodiments, the body is having a first side and a second side, the first side and the second side are correspondingly arranged, and the optical path adjusting rod is having an optical path adjusting rod head and an optical path adjusting rod tail, the optical path adjusting rod head is located on the second side of the body, the optical path adjusting rod tail is located on the first side of the body.

In some embodiments, the body is having a first side and a second side, the first side and the second side are correspondingly arranged, and the body is further comprising a detection exit, the detection exit is located on the first side of the body, and the detection exit is disposed close to the sample under test.

In some embodiments, the body is having a first side and a second side, the first side and the second side are correspondingly arranged, and the body is further comprising a Microelectromechanical Systems circuit adapter board and a Microelectromechanical Systems scan mirror, the Microelectromechanical Systems circuit adapter board is connected to the Microelectromechanical Systems scan mirror, the Microelectromechanical Systems circuit adapter board and the Microelectromechanical Systems scan mirror is located on the second side of the body.

In some embodiments, the body is having a first side and a second side, the first side and the second side are correspondingly arranged, and the body is further comprising an auxiliary rod, the auxiliary rod is having an auxiliary rod head and an auxiliary rod tail, the auxiliary rod head is located on the second side of the body, and the auxiliary rod tail is disposed through the body.

Accordingly, in the optical path length adjusting device of the present invention, the optical path moving shaft is driven by the optical path adjusting rod, so that the distance between optical path length emitted by the optical fiber optical path moving shaft and the main body can be changed, and also adjust the emitted light path. At the same time, due to the cooperation of the auxiliary rod and the connecting plate, the optical path moving shaft can move more stably, and there will be no deviation during adjustment.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts an optical path length adjusting device according to various embodiments of this invention.

FIG. 2 depicts an optical path length adjusting device according to various embodiments of this invention.

FIG. 3 depicts a cross-sectional view of an optical path length adjusting device to various embodiments of this invention.

### DETAILED DESCRIPTION

An optical path length adjusting device is described herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

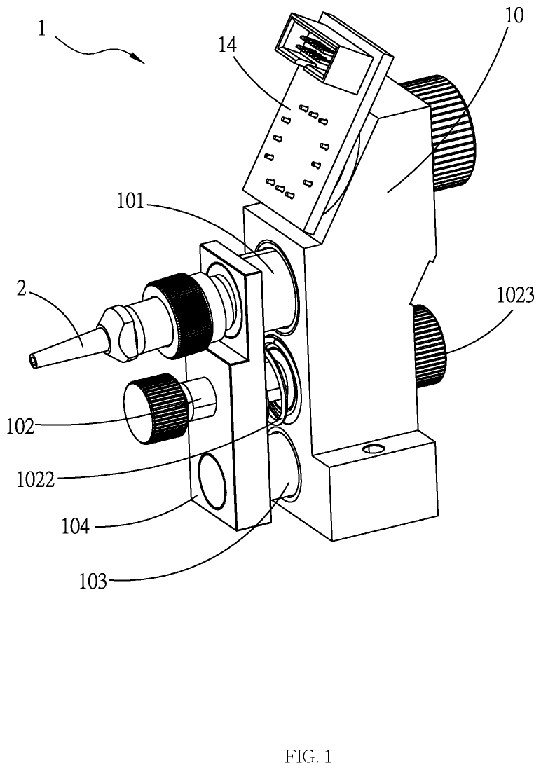

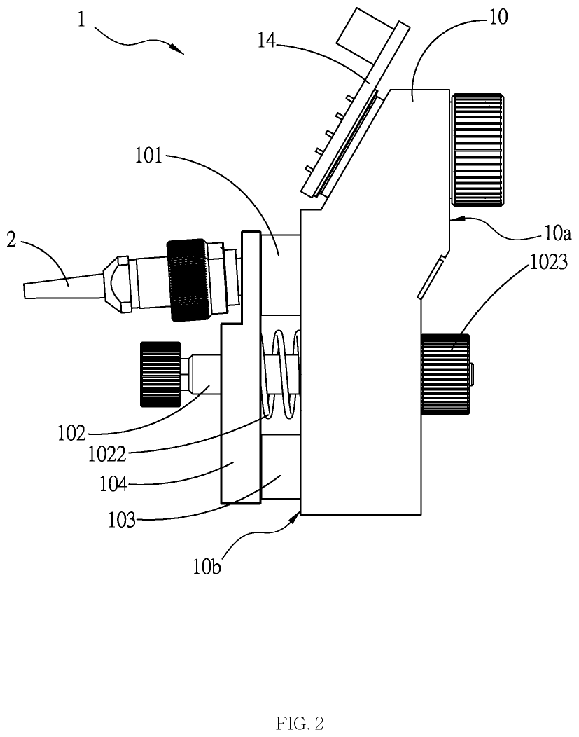

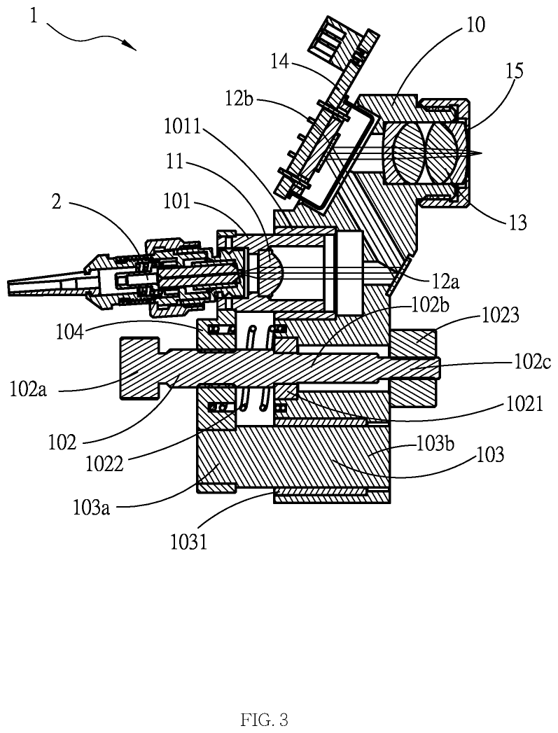

The optical path length adjusting device is integrated in the detection probe and is set at the place close to at least a sample under test. One end of the optical path length adjusting device is connected to the optical fiber. When the optical signal is transmitted from the optical fiber to the optical path length adjustment device, the optical signal is transmitted to the sample under test through the lens and reflector in the optical path length adjustment device, and then the optical signal fed back by the sample under test. The present invention will now be described by referencing the appended figures representing preferred embodiments. FIG. 1 shows a first perspective of an optical path length adjusting device to various embodiments of the present invention. FIG. 2 shows a second perspective of an optical path length adjusting device to various embodiments of the present invention. FIG. 3 shows a first cross-sectional view of an optical path length adjusting device according to various embodiments of this invention.

The optical path length adjusting device 1 comprises a body 10, an optical path moving shaft 101, and an optical path adjusting rod 102 and a connecting plate 104. The optical path moving shaft 101 connects to the body 10, and the optical fiber 2 is disposed in the optical path moving shaft 101. The optical path adjusting rod 102 is configured through the body 10, and the optical path adjusting rod 102 rotates relative to the body 10. The connecting plate 104 connects to the optical path moving shaft 101 and the optical path adjusting rod 102, when the optical path adjusting rod 102 rotating relative to the body 10, the connecting plate 104 moving on the optical path adjusting rod 102 and driving the optical path moving shaft 101 to move relative to the body 10.

The present invention uses bearings to stabilize the movement of the optical path moving shaft in a single direction, and uses the rotation of the optical path adjusting rod to move the optical path moving shaft to closer to or away from the body. The above-mentioned driving structure will be further explained by the following description. Please continue to refer to FIG. 1, FIG. 2 and FIG. 3. The optical path length adjusting device 1 further comprises a first linear bearing 1011, the first linear bearing 1011 is disposed on the body 10, and the optical path adjusting rod 102 is connected to the body 10 through the first linear bearing 1011. The optical path length adjusting device 1 further comprises a spring 1022, the spring 1022 is disposed through the optical path adjusting rod 102, and located between the connecting plate 104 and the body 10. The optical path length adjusting device further comprises a ball bearing 1021, the ball bearing 1021 is disposed on the body 10, and the optical path adjusting rod 102 is disposed through the ball bearing 1021. The optical path length adjusting device 1 further comprises a fixing nut 1023, the fixing nut 1023 is disposed on the body 10, and one end of the optical path adjusting rod 102 is disposed through the fixing nut 1023. That is, multiple elements like the spring 1022, the ball bearing 1021, and the fixing nut 1023 are provided on the optical path adjusting rod 102. The ball bearing 1021 has a ball (not shown in the figure) in the middle to cause the ball bearing 1021 and the optical path adjusting rod 102 in a close-fitting relationship, and the outer part of the ball bearing 1021 and the body 10 are also in a close-fitting relationship. Therefore, when the optical path adjusting rod 102 is rotated, it will rotate relative to the body 10 in the original place. When the optical path adjusting rod 102 rotates clockwise or counterclockwise, the connecting plate 104 can be driven toward or away from the body 10. The spring 1022 between the connecting plate 104 and the body 10 can eliminate the gap between the optical path adjusting rod 102 and the connecting plate 104.

The connection between the connecting plate 104 and the optical path adjusting rod 102 can be achieved by setting screws (not shown in the figure), when the connecting plate 104 and the optical path adjusting rod 102 are connected by setting screws, the spring 1022 between the connecting plate 104 and the body 10 can eliminate the backlash of the screw, that is, eliminate the gap between the outer screw of the optical path adjusting rod 102 and the inner screw of the connecting plate 104. However, the connection way between the connecting plate and the optical path adjusting rod is not limited in the present invention.

Furthermore, the optical path adjusting rod 102 has an optical path adjusting rod head 102a, an optical path adjusting rod body 102b and an optical path adjusting rod tail 102c, wherein the optical path adjusting rod body 102b is connected to the optical path adjusting rod head 102a and the optical path adjusting rod tail 102c. The outer diameter of the optical path adjusting rod head 102a is not less than the outer diameter of the optical path adjusting rod body 102b. The outer diameter of the optical path adjusting rod tail 102c is not greater than the outer diameter of the optical path adjusting rod body 102b.

The optical path length adjusting device 1 further comprises an auxiliary rod 103, the auxiliary rod 103 is connected to the body 10 and the connecting plate 104. The auxiliary rod 103 is disposed on the second linear bearing 1031, and the second linear bearing 1031 is disposed on the body 10. The outer diameter of the auxiliary rod 103 is not less than the outer diameter of the optical path adjusting rod 102. The arrangement of the auxiliary rod 103 and the second linear bearing 1031 enhance the stability of the optical path moving shaft 101 when it moves. In addition, the distance between the optical path moving shaft 101 and the first linear bearing 1011 has a certain limit. When the limit is exceeded, the angle of the optical path may change. The dispose of the second linear bearing 1031 can solve the above-mention problem, the second linear bearing 1031 enhances the stability of linear motion. In this way, in the process of adjusting the optical path, the path angle of the optical axis will not be changed and the quality of the focused light spot during light focusing will not be affected.

The optical path length adjusting device 1 further comprises a parallel light lens 11, a reflecting mirror 12a and a focusing lens 13, a Microelectromechanical Systems(MEMS) circuit adapter board 14 and a Microelectromechanical Systems(MEMS) scan mirror 12b. The parallel light lens 11 is disposed in the optical path moving shaft 101. The reflecting mirror 12a is disposed on the body 10. The focusing lens 13 is disposed on the body 10. The Microelectromechanical Systems circuit adapter board 14 is connected to the Microelectromechanical Systems scan mirror 12b, and the Microelectromechanical Systems circuit adapter board 14 is disposed on the body 10. The Microelectromechanical Systems scan mirror 12b can rotate for two axes for scanning.

The optical path length adjusting device 1 further comprising a detection exit 15, the optical path length emitted from the optical fiber 2 is sequentially along the parallel light lens 11, the reflecting mirror 12a, the Microelectromechanical Systems scanning mirror 12b and the focusing lens 13 to the detection exit 15.

The body 10 of the optical path length adjusting device 1 having a first side 10a and a second side 10b. The first side 10a and the second side 10b are correspondingly arranged, and the optical fiber 2, the optical path moving shaft 101 and the connecting plate 104 are located on the second side 10b of the body 10. The optical path adjusting rod head 102a is located on the second side 10b of the body. The optical path adjusting rod tail 102c is located on the first side 10a of the body. The detection exit 15 is located on the first side 10a of the body 10, and the detection exit 15 is disposed close to the sample under test. The Microelectromechanical Systems circuit adapter board 14 and the Microelectromechanical Systems scan mirror 12b is located on the second side of the body 10. The auxiliary rod 103 has an auxiliary rod head 103a and an auxiliary rod tail 103b, the auxiliary rod head 103a is located on the second side 10b of the body 10, and the auxiliary rod tail 103b is disposed through the body 10.

Accordingly, an optical path adjusting device is provided in the present invention. When light enters the optical path adjusting device from an optical fiber, the optical path is sequentially along the parallel light lens, reflecting mirror, MEMS scanning mirror and focusing lens to the detection exit. With the optical path adjusting rod driving the optical path moving shaft, the distance between the optical fiber and the body can be changed. With the cooperation between the optical path moving shaft, the optical path adjusting screw, the auxiliary rod, and the connecting plate, the optical path can be adjusted after the light injected from the optical fiber into the optical path adjusting device. It means that the distance between the light source and the focal point of the focusing lens is adjusted. In this way, the sample can be clearly observed when the sample is placed at the focal position of the focusing lens.

Accordingly, since the optical path adjustment device is integrated on the probe, when multiple probes are required to scan and detect the sample under test, the path adjustment device can adjust the optical path of each probe at any time to cause a certain time difference in the optical signal returned by each probe, so that the receiving end can clearly distinguish the source of the signal. The optical path length adjusting device mentioned above can apply to various fields, such as industrial inspection, industrial detection and biological detection. For instance, the industrial inspection and/or the industrial detection includes the inspection/detection of semiconductor elements (ex. wafer, package and so on) as well as the inspection/detection of panel elements. The biological detection includes the skin detection of epidermis, dermis, subcutaneous tissue. To achieve the purposes mentioned, the optical path length adjusting device may further assemble to proper optical modules to form an optical device, wherein the optical modules can be selected from interference elements, light sources, transmitted elements, probes and so on. Moreover, the optical device can have at least one probe for inspection/detection.

The presently-disclosed inventive concepts are not intended to be limited to the embodiments shown herein, but are to be accorded their full scope consistent with the principles underlying the disclosed concepts herein. Directions and references to an element, such as “up,” “down,”, “upper,” “lower,” “horizontal,” “vertical,” “left,” “right,” and the like, do not imply absolute relationships, positions, and/or orientations. Terms of an element, such as “first” and “second” are not literal, but, distinguishing terms. As used herein, terms “comprises” or “comprising” encompass the notions of “including” and “having” and specify the presence of elements, operations, and/or groups or combinations thereof and do not imply preclusion of the presence or addition of one or more other elements, operations and/or groups or combinations thereof. Sequence of operations do not imply absoluteness unless specifically so stated. Reference to an element in the singular, such as by use of the article “a” or “an”, is not intended to mean “one and only one” unless specifically so stated, but rather “one or more”. As used herein, “and/or” means “and” or “or”, as well as “and” and “or.” As used herein, ranges and subranges mean all ranges including whole and/or fractional values therein and language which defines or modifies ranges and subranges, such as “at least,” “greater than,” “less than,” “no more than,” and the like, mean subranges and/or an upper or lower limit. All structural and functional equivalents to the elements of the various embodiments described throughout the disclosure that are known or later come to be known to those of ordinary skill in the relevant art are intended to be encompassed by the features described and claimed herein. Moreover, nothing disclosed herein is intended to be dedicated to the public regardless of whether such disclosure may ultimately explicitly be recited in the claims. No element or concept disclosed herein or hereafter presented shall be construed under the provisions of 35 USC 112(f) unless the element or concept is expressly recited using the phrase “means for” or “step for”.

In view of the many possible embodiments to which the disclosed principles can be applied, we reserve the right to claim any and all combinations of features and acts described herein, including the right to claim all that comes within the scope and spirit of the foregoing description, as well as the combinations recited, literally and equivalently, in the following claims and any claims presented anytime throughout prosecution of this application or any application claiming benefit of or priority from this application.

What is claimed is:

1. An optical path length adjusting device, using for setting at least a sample under test, and adjusting an optical path length from an optical fiber, the optical path length adjusting device comprising:
a body;
an optical path moving shaft, connected to the body, and the optical fiber is disposed in the optical path moving shaft;
an optical path adjusting rod, configured through the body, and the optical path adjusting rod rotating relative to the body; and
a connecting plate, connected to the optical path moving shaft and the optical path adjusting rod, when the optical path adjusting rod rotating relative to the body, the connecting plate moving on the optical path adjusting rod and driving the optical path moving shaft to move relative to the body.

2. The optical path length adjusting device of claim 1, further comprising a first linear bearing, the first linear bearing is disposed on the body, and the optical path adjusting rod is connected to the body through the first linear bearing.

3. The optical path length adjusting device of claim 1, further comprising a spring, the spring is disposed through the optical path adjusting rod, and located between the connecting plate and the body.

4. The optical path length adjusting device of claim 1, further comprising a ball bearing, the ball bearing is disposed on the body, and the optical path adjusting rod is disposed through the ball bearing.

5. The optical path length adjusting device of claim 1, further comprising a fixing nut, the fixing nut is disposed on the body, and one end of the optical path adjusting rod is disposed through the fixing nut.

6. The optical path length adjusting device of claim 1, further comprising a spring, a ball bearing and a fixing nut, and the optical path adjusting rod having an optical path adjusting rod head, an optical path adjusting rod body and an optical path adjusting rod tail, the spring and the ball bearing are disposed through the optical path adjusting rod body in sequence, and the fixing nut is disposed through the optical path adjusting rod tail.

7. The optical path length adjusting device of claim 1, wherein the optical path adjusting rod having an optical path adjusting rod head, an optical path adjusting rod body and an optical path adjusting rod tail, the optical path adjusting rod body is connected to the optical path adjusting rod head and the optical path adjusting rod tail, and the outer diameter of the optical path adjusting rod head is not less than the outer diameter of the optical path adjusting rod body, the outer diameter of the optical path adjusting rod tail is not greater than the outer diameter of the optical path adjusting rod body.

8. The optical path length adjusting device of claim 1, further comprising an auxiliary rod, the auxiliary rod is connected to the body and the connecting plate.

9. The optical path length adjusting device of claim 1, further comprising an auxiliary rod and a second linear bearing, the auxiliary rod is connected to the connecting plate, the auxiliary rod is disposed on the second linear bearing, and the second linear bearing is disposed on the body.

10. The optical path length adjusting device of claim 1, further comprising an auxiliary rod, the auxiliary rod is connected to the body and the connecting plate and the outer diameter of the auxiliary rod is not less than the outer diameter of the optical path adjusting rod.

11. The optical path length adjusting device of claim 1, further comprising a parallel light lens, the parallel light lens is disposed in the optical path moving shaft.

12. The optical path length adjusting device of claim 1, further comprising a reflecting mirror, the reflecting mirror is disposed on the body.

13. The optical path length adjusting device of claim 1, further comprising a focusing lens, the focusing lens is disposed on the body.

14. The optical path length adjusting device of claim 1, further comprising a Microelectromechanical Systems(MEMS) circuit adapter board and a Microelectromechanical Systems(MEMS) scan mirror, the Microelectromechanical Systems circuit adapter board is connected to the Microelectromechanical Systems scan mirror, and the Microelectromechanical Systems circuit adapter board is disposed on the body.

15. The optical path length adjusting device of claim 1, further comprising a parallel light lens, a reflecting mirror and a Microelectromechanical Systems scan mirror, a focusing lens and a detection exit, the optical path length emitted from the optical fiber is sequentially along the parallel light lens, the reflecting mirror, the Microelectromechanical Systems scanning mirror and the focusing lens to the detection exit.

16. The optical path length adjusting device of claim 1, wherein the body is having a first side and a second side, the first side and the second side are correspondingly arranged, and the optical fiber, the optical path moving shaft and the connecting plate are located on the second side of the body.

17. The optical path length adjusting device of claim 1, wherein the body is having a first side and a second side, the first side and the second side are correspondingly arranged, and the optical path adjusting rod is having an optical path adjusting rod head and an optical path adjusting rod tail, the optical path adjusting rod head is located on the second side of the body, the optical path adjusting rod tail is located on the first side of the body.

18. The optical path length adjusting device of claim 1, wherein the body is having a first side and a second side, the first side and the second side are correspondingly arranged, and the body is further comprising a detection exit, the detection exit is located on the first side of the body, and the detection exit is disposed close to the sample under test.

19. The optical path length adjusting device of claim 1, wherein the body is having a first side and a second side, the first side and the second side are correspondingly arranged, and the body is further comprising a Microelectromechanical Systems circuit adapter board and a Microelectromechanical Systems scan mirror, the Microelectromechanical Systems circuit adapter board is connected to the Microelectromechanical Systems scan mirror, the Microelectromechanical Systems circuit adapter board and the Microelectromechanical Systems scan mirror is located on the second side of the body.

20. The optical path length adjusting device of claim 1, wherein the body is having a first side and a second side, the first side and the second side are correspondingly arranged, and the body is further comprising an auxiliary rod, the auxiliary rod is having an auxiliary rod head and an auxiliary rod tail, the auxiliary rod head is located on the second side of the body, and the auxiliary rod tail is disposed through the body.
